(19) United States
(12) Patent Application Publication
(10) Pub. No.: US 2016/0250930 A1
(43) Pub. Date: Sep. 1, 2016

(54) SLIP MITIGATION CONTROL FOR ELECTRIC GROUND VEHICLES

(71) Applicant: The Florida State University Research Foundation, Inc., Tallahassee, FL (US)

(72) Inventors: Emmanuel G. Collins, Tallahassee, FL (US); Oscar Chuy, JR., Tallahassee, FL (US)

(21) Appl. No.: 15/131,689

(22) Filed: Apr. 18, 2016

Related U.S. Application Data
(63) Continuation of application No. PCT/US14/61089, filed on Oct. 17, 2014.
(60) Provisional application No. 61/892,587, filed on Oct. 18, 2013.

(51) Int. Cl. B60L 3/10; B60L 3/12

(52) U.S. Cl. CPC B60L 3/106; B60L 3/12; B60L 2240/423; B60L 2240/465; B60L 2240/16; B60L 2240/12; B60L 2240/62

(57) ABSTRACT

The present invention is a traction control system utilizing a reference model based on a mass-damper system, a trajectory tracking controller, and a maximum tractive force estimator. The reference model generates the desired acceleration, velocity, and position of the vehicle based on user inputs, which are mapped, to force and torque inputs, to the reference model. The commanded trajectory is mapped to the desired wheel trajectories. Each wheel follows its desired trajectory using the trajectory tracking controller. The maximum tractive force estimator determines the minimum of the maximum tractive forces applicable to each wheel based on traversing surface. An associated lower bound on the reference model's mass determines when a wheel must follow a trajectory requiring more than the estimated min-max tractive force, inferring that slip has occurred or may soon occur. Subsequently, the reference model's mass parameter value is reduced to prevent future slip.

### CROSS-REFERENCE TO RELATED APPLICATIONS

This non-provisional application is a continuation of PCT Patent Application No. PCT/US2014/061089 entitled “SLIP MITIGATION CONTROL FOR ELECTRIC GROUND VEHICLES,” filed Oct. 17, 2014 which claims priority to U.S. Provisional Application No. 61/892,587, filed Oct. 18, 2013, which is herein incorporated by reference.

### FEDERALLY SPONSORED RESEARCH OR DEVELOPMENT

This invention was made with Government support under Grant No. EEC-0540865 awarded by National Science Foundation. The government has certain rights in the invention.

### BACKGROUND OF THE INVENTION

1. Field of the Invention

This invention relates, generally, to electric ground vehicles. More specifically, it relates to slip mitigation of electric ground vehicles.

2. Brief Description of the Prior Art

Electric Ground Vehicles (EGVs) such as electric automobiles, golf carts, and electric powered wheelchairs are increasing in use because they are energy efficient, environmentally friendly, and oil independent. EGVs are often required to traverse slippery surfaces making them susceptible to longitudinal slip. Such conditions are dangerous and can result in serious injury, especially when the ground vehicle is an electric powered wheelchair. Currently, traction control systems for EGVs are insufficient to adequately mitigate longitudinal slip.

Currently, there exists a traction control approach developed based on reducing the desired velocity when slip is detected [13]. The calculation of slip was based on an encoder attached to a caster wheel. Considering that a caster wheel is free to rotate about the vertical axis, the velocity of the caster must be projected along the direction of the drive wheels. This requires the use of an absolute position sensor to monitor the orientation of the castor. This method has problems in accurately estimating the actual slip, especially when an EGV traverses uneven terrain.

Model Following Control (MFC) is a traction control methodology for electric vehicles [5], [6] and was introduced along with optimal slip control, which is discussed further in the following paragraph. In the MFC framework, the commanded torque τ_{d,i} to wheel i is inputted to the vehicle model, expressed about a coordinate axis centered at the corresponding wheel, to determine ω_{p,i}, which is a prediction of the wheel angular velocity. The actual wheel velocity ω_{α,i} is measured and the controller torque τ_{c,i} is given by τ_{c,i}=K_{MFC,i}(ω_{α,i}−ω_{p,i}), where K_{MFC,i} is the MFC gain. The torque τᵢ=τ_{d,i}−τ_{α,i}−ω_{p,i} is then applied to wheel τᵢ. Note that as the wheel slips, ω_{α,i} increases, increasing Ω_{α,i}−ω_{p,i} and thereby reducing τᵢ. One limitation of MFC is that the MFC gain is dependent upon the terrain surface or road condition and variations in this condition can severely change the performance of the traction control.

The desire to achieve a specific slip ratio led to several studies in slip control [3], [4], [6], [9], and [11]. However, the more fundamental problem is to determine the optimal slip ratio. Based on FIG. 1, the slip ratio λ should be in {λ:0<λ≦λₒₚₜ}, where λₒₚₜ is the slip ratio corresponding to μₘₐₓ, the maximum coefficient of friction corresponding to the tractive force. However, λₒₚₜ varies with both the terrain type and surface conditions (e.g., degree of wetness). In [5], [6], [9], a proportional plus integral (PI) controller was used to drive λ to λₒₚₜ, which was determined offline. The output torque of the PI controller was subtracted from the commanded torque and the actual slip ratio was determined by comparing the velocity of the driven wheels with the velocity of the non-driven wheels. The problems of the aforementioned slip control are as follows: 1) the methodology of determining the actual slip ratio is not applicable to all-wheel drive vehicles without redundant wheels, and 2) λₒₚₜ must be determined online for practical implementation, which is difficult to achieve. Although online approaches to estimate λₒₚₜ have been presented [10], [12], the estimates can be inaccurate due to sensor noise, especially since the approaches require differentiating noisy signals. The above limitations led to development of a traction control approach that does not depend on λₒₚₜ [14], [15], called the Maximum Transferable Torque Estimate approach.

Traction control approaches discussed in [5], [6], [14], and [15] generally alter the commanded torque to the wheels when slip occurs. Hence, to develop traction control for an EPW, a control methodology that can directly or indirectly control the commanded torque and addresses human joystick interaction as needed. In [1], joystick positions are mapped into velocity and direction commands. For example, in the longitudinal direction, the linear velocity is vₓ=kₓpₓ, where pₓ is the joystick displacement and kₓ is a proportionality constant. The acceleration and position components can then be determined respectively by differentiating and integrating the velocity vₓ. Although the acceleration command plays a major part in the resulting command torque, this approach does not enable control of the acceleration since the model parameter kₓ only directly effects the velocity component.

Additionally, the resulting trajectory is not smooth since the sensor noise in pₓ directly influences the commanded velocity. Hence, although this approach does map human intention to a commanded trajectory, it cannot be used to implement slip reduction.

Omni-directional motorized walkers have been controlled using mass-damper systems as reference models, one for each degree of freedom (x,y,θ) [7], [8], [16]. The human intentions, read by a force/torque sensor, are represented by the forces fₓ and f_{y} and the torque n_{z}, which are fed to reference models to yield commanded trajectories for the robotic walkers. The parameters of the reference models are selected based on the physical constraints (e.g., maximum walking speed) of the user and also the constraints (e.g., maximum acceleration and velocity) of the robot system. For example, along the longitudinal direction, the reference model is mₓ\ddot{x}+dₓ\dot{x}=fₓ. The parameter dₓ is chosen to satisfy dₓ≧fₓ_{ₘₐₓ}/vₓ_{ₘₐₓ}, where fₓ_{ₘₐₓ} represents the force corresponding to the maximum human input along the longitudinal direction and vₓ_{ₘₐₓ} is the maximum desired velocity \dot{x} along the longitudinal direction. The parameter mₓ is chosen to satisfy mₓ≧fₓ_{ₘₐₓ}/aₘₐₓ, where aₘₐₓ is the maximum desired acceleration along the longitudinal direction.

The above reference model approach provides a viable structure to implement slip mitigation control since it can indirectly alter the commanded torque by modifying the mass parameter. Such an approach is developed here and unlike [7], [8], [16] is heavily dependent upon an estimate of the maximum tractive forces that can be applied to each wheel. These estimates are ultimately used to develop a lower bound on mₓ that must be satisfied to avoid slip. Hence to mitigate slip, the control approach varies mₓ, which is a novel concept in slip reduction.

The current slip and traction control methodologies are based on directly limiting the applied torque to the motors, which is highly applicable to open-loop systems where there is no trajectory tracking controller [5], [14], and [15]. However, when feedback control is employed, which is preferable for smoother performance and semi-autonomous operation, directly limiting the applied torque can create substantial tracking errors, which accumulate over time.

Accordingly, what is needed is a slip mitigation system (or traction control system) capable of creating a feasible trajectory that can be followed by the trajectory following controllers for each wheel with little or no slip, mitigating slip without accumulating commanded trajectory errors, and addressing slip using a reference model method that is able to generate smooth commanded trajectories. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for an improved traction control system is now met by a new, useful, and nonobvious invention.

The novel system includes a reference model, a maximum tractive force estimator, and a trajectory tracking controller. The reference model generates a desired acceleration, velocity, and position of the vehicle based on user inputs; the maximum tractive force estimator determines the minimum of the maximum tractive forces that can be applied to the wheels; and the trajectory tracking controller controls the wheels' trajectories. The user inputs are mapped to the reference model and the command trajectories are mapped to the trajectory tracking controller. Additionally, a lower bound mass parameter of the reference model is generated. The wheels' kinematics are monitored to determine when a wheel is required to follow a trajectory that requires more than the minimum of the maximum tractive force. When such an occurrence transpires the mass parameter of the reference model is altered to reduce the help ensure that future slip will not occur.

In a certain embodiment, the lower bound mass parameter of the reference model is generated using a Jacobian matrix of the electric ground vehicle to transform a constraint on wheel acceleration to a constraint on electric ground vehicle acceleration and in turn yield the lower bound mass parameter of the reference model.

In a certain embodiment, the mapping of a commanded trajectory is accomplished using an inverse of a Jacobian matrix of the electric ground vehicle. In a certain embodiment, the mapping of user inputs includes force inputs and torque inputs.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 depicts a graphical illustration of the relationship between the friction coefficient and the slip ratio.

FIG. 2 depicts an embodiment of the general control architecture for the traction control system.

FIG. 3 depicts a control flow diagram for a trajectory tracking controller, for wheel i.

FIG. 4 depicts a control flow diagram for a minimum-maximum tractive force estimator.

FIG. 5 is a flow chart of a certain embodiment of the present invention.

FIG. 6 depicts a loss of direction control of an EGV without slip mitigation control when one or more of the wheels move on a slippery surface.

FIG. 7a depicts vehicle dynamics about wheel i.

FIG. 7b depicts a control flow diagram for a Maximum Transferable Torque Estimate (MTTE) approach to slip mitigation control.

FIG. 8 depicts a control flow diagram for a trajectory tracking controller for wheel i.

FIG. 9 depicts the general control architecture for the traction control system used in the mathematical study.

FIG. 10 depicts the kinematic diagram of the electric powered wheelchair used in the mathematical study.

FIG. 11a depicts a graphical illustration showing the difference in tractive forces between the right and left wheels, of an electric powered wheel chair lacking the present invention, when the right wheel loses traction.

FIG. 11b depicts a graphical illustration showing the difference in tractive forces between the right and left wheels, of an electric powered wheel chair utilizing the traction control system of the present invention, when the right wheel loses traction.

FIGS. 12a-12d depict an electric powered wheel chair in the mathematical study lacking the present invention, as it traverses a slippery surface.

FIGS. 13a-13d depict an electric powered wheel chair in the mathematical study utilizing the traction control system of the present invention, as it traverses a slippery surface.

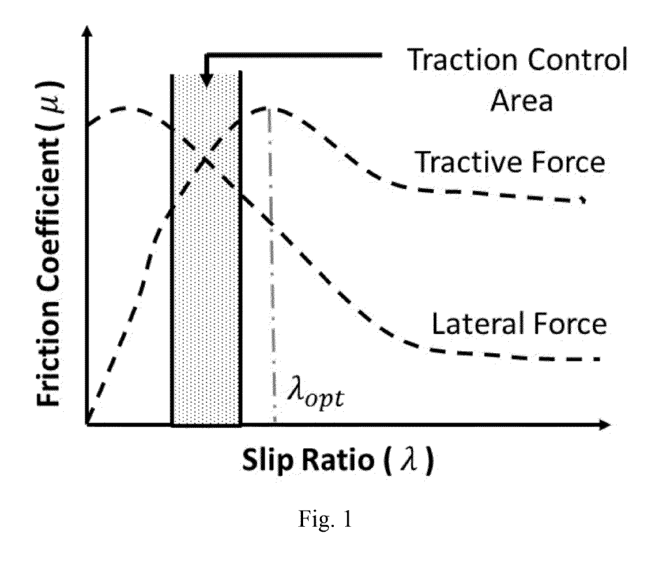

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

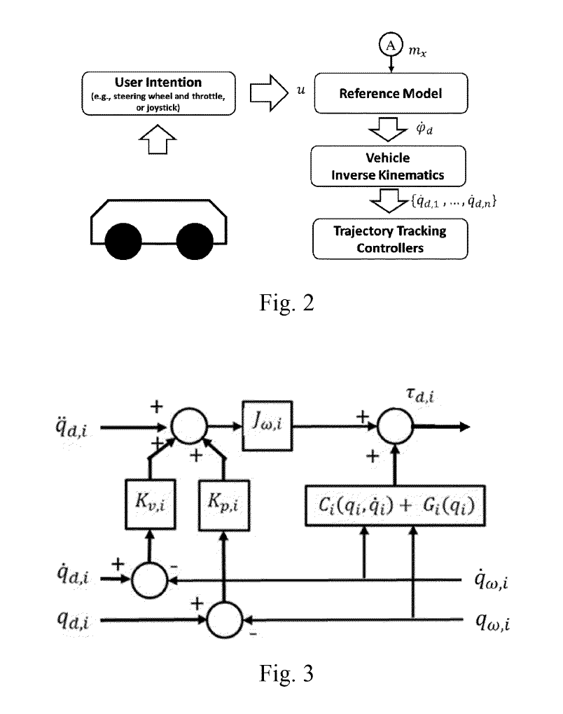

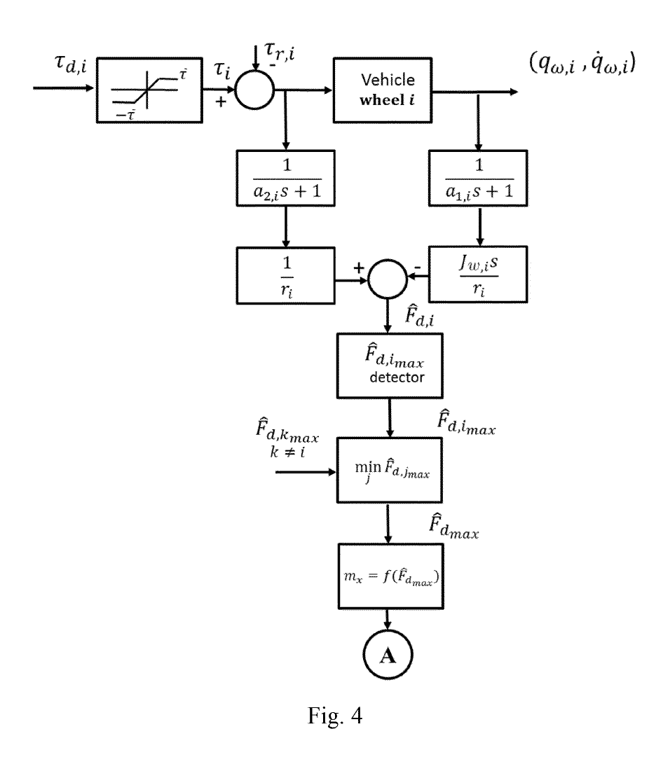

The present invention is a slip mitigation system (or traction control system) capable of creating a feasible trajectory that can be followed by the trajectory following controllers for each wheel with little or no slip, mitigating slip without accumulating commanded trajectory errors, and addressing slip using a reference model method that is able to generate smooth commanded trajectories that are more preferable to the vehicle users. Longitudinal slip is mitigated using a feedback control. The system utilizes a reference model based on mass-damper system (See FIG. 2), a trajectory tracking controller (See FIG. 3) for each wheel, and a maximum tractive force estimator (See FIG. 4). FIG. 5 provides a certain embodiment of the interactions and operations of the reference model, controller, and estimator identified above. The reference model generates the desired acceleration, velocity, and position of the vehicle based on user inputs, which may be, for example, the positions of the steering wheel and throttle or the commands from a joystick displacement (Step 502). The user inputs are mapped in force and torque inputs to the reference model (Step 504). The commanded trajectory is mapped to the desired wheel trajectories using the inverse of the vehicle Jacobian matrix. Each wheel then follows its desired trajectory using the trajectory tracking controller (Step 506). The maximum tractive force estimator determines the minimum of the maximum tractive forces that can be applied to each wheel by the surface the wheel is traversing (Step 508). An associated lower bound on the mass of the reference model is used to determine when one or more of the wheels has been required to follow a trajectory that requires more than the estimate of the min-max tractive force, such that it can be inferred that slip has occurred or may soon occur (Step 510). Subsequently, the value of the mass parameter in the reference model is reduced to help ensure that future slip will not occur (Step 512).

Certain embodiments may utilize other exteroceptive sensors known to a person having ordinary skill in the art, such as an inertial measurement unit, to improve the accuracy of the estimation of the tractive forces.

Mathematical Study

The following analysis is a mathematical study for an approach to longitudinal slip reduction (or traction control) for an electric powered wheelchair (EPW) using a variable reference model, which is a mass damper system.

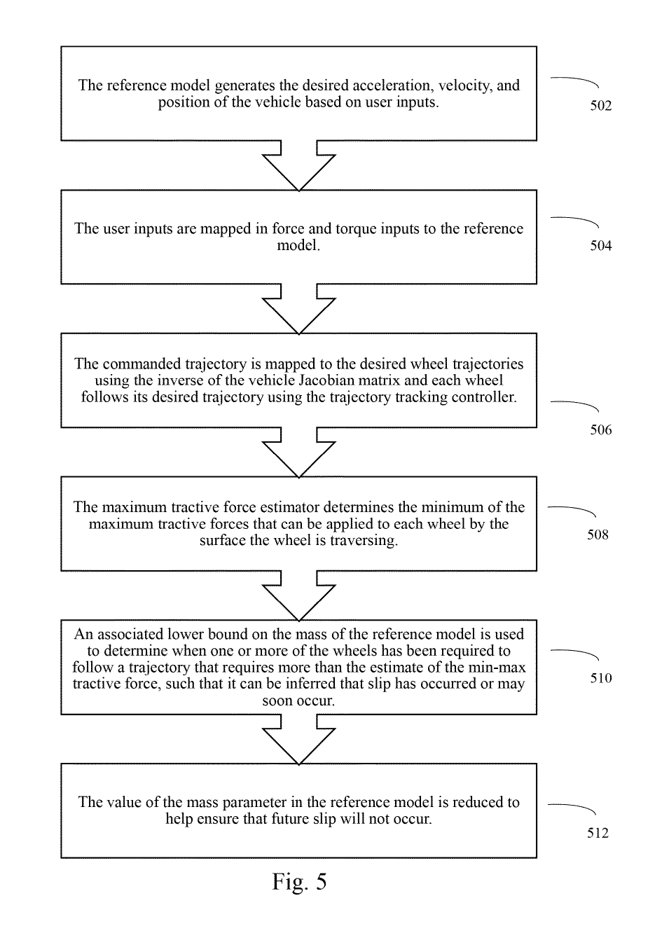

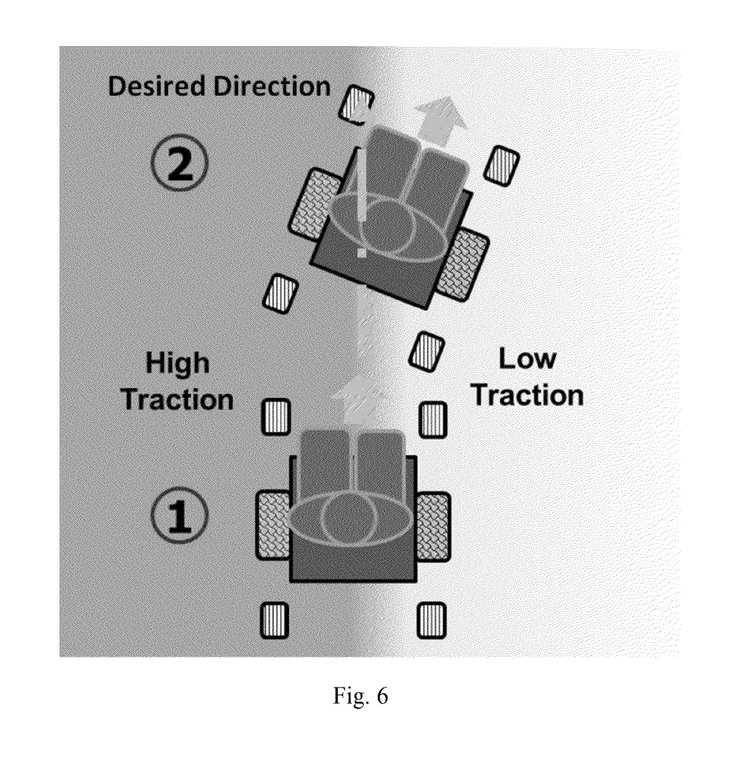

EPWs are typically driven by only two wheels and have caster wheels in the front and/or back. Hence, they are either mid-drive (caster wheels in the front and back), rear drive (caster wheels only in the front), or front drive (caster wheels only in the back) systems. Although caster wheels provide vertical stability, they do not increase lateral stability, and hence EPWs have inherently low lateral stability. It follows that a loss of traction in one of the wheels will significantly alter their heading direction as shown in FIG. 6, endangering the safety of the users.

An approach, which can be applied to EPWs, is to indirectly alter the applied motor torque through the command trajectory when slip occurs. This can be achieved by modifying the desired reference model for EPWs so that the resulting command motor torque is within the limits that ensure little or no wheel slip.

Maximum Tractive Force Estimation

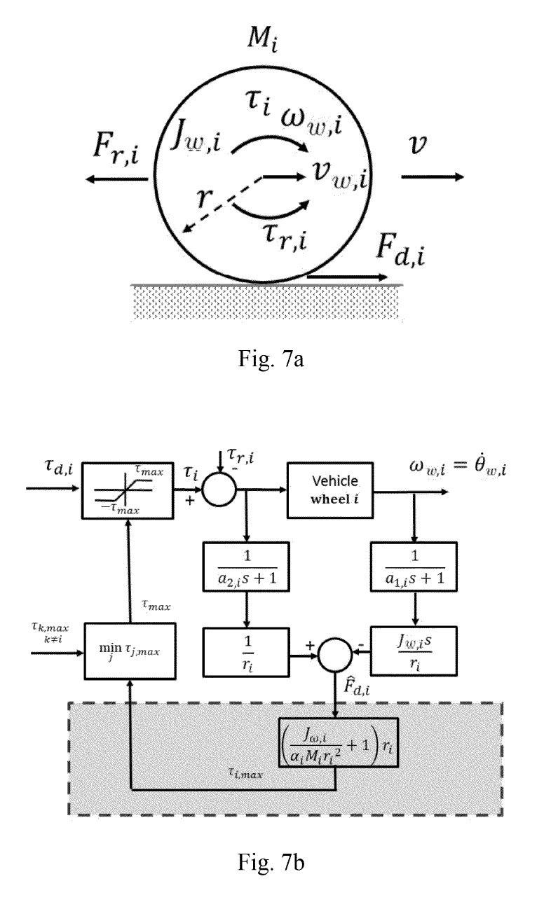

Assume that a vehicle has n wheels. In [14], [15] the vehicle model expressed about wheel i is considered, as shown in FIG. 7(a). The corresponding rotational dynamics are described by

J_{ω,i}\dot{ω}_{ω,i}=τᵢ−τ_{r,i}−rF_{d,i} (1)

where J_{ω,i} is the wheel inertia, \dot{ω}_{ω,i} is the wheel angular acceleration, τᵢ is the torque applied to the wheel, rᵢ is the wheel radius and F_{d,i} is the tractive force. The translational dynamics of the vehicle may be described in terms of wheel i by

Mᵢ\dot{v}ᵢ=F_{d,i}−F_{r,i} (2)

where vᵢ is the translational velocity of wheel i, Mᵢ is the mass of the vehicle seen by wheel i, and F_{r,i} is the resistance term (i.e., rolling resistance and drag) experienced at wheel i. Note that the total mass of the vehicle is given by M=Σᵢ₌₁ⁿMᵢ and the total resistance is given by Fᵣ=Σᵢ₌₁ⁿF_{r,i}. The Maximum Transferrable Torque Estimate (MITE) approach [14], [15] requires solving for the maximum torque τ_{i,max} that achieves a desired value of αᵢ>\dot{v}ᵢ/\dot{v}_{ω,i}, which is the ratio of the actual translational acceleration to the estimate of the translational acceleration based on the wheel i angular acceleration. For the vehicle not to experience excessive slip, αᵢ<1 should satisfy αᵢ≈1. Equations (1) and (2) can be solved for τ_{i,max}(=τᵢ) which under the assumptions τ_{r,i}=0 and

F_{r,i}<<F_{d,i} yields τ_{i,max}=(J_{ω,i}/(αᵢMᵢrᵢ²)+1)rᵢF_{d,i}

FIG. 7(b) shows how the tractive force \hat{F}_{d,i} is estimated. It also shows that if the commanded torque τ_{d,i}>τₘₐₓ, where τₘₐₓ=min_{j∈{1,2, . . . n}}τ_{j,max}, then τᵢ=τ_{d}_{ₘₐₓ}, otherwise τᵢ=τ_{d,i}. In MITE, τₘₐₓ is varied instead of directly altering τᵢ as done in [6]. The results in [5], [14], and [15] show that if slip occurs, the control approach shown in FIG. 7(b) is able to prevent further slip. However, in a control framework that uses a trajectory tracking controller, directly modifying the control torque τᵢ causes undesirable trajectory errors, which grow over time. Hence, commands were developed to ensure that the wheel angular acceleration is modified such that for each wheel \hat{F}_{d,i}<\hat{F}_{d}_{ₘₐₓ}=min_{j∈{1,2, . . . n}}\hat{F}_{d,j}_{ₘₐₓ}, where \hat{F}_{d,j}_{ₘₐₓ} is an estimate of the maximum tractive force for wheel j on the surface it is contacting.

Experimental Setup

The EPW experimental platform used in the study was a commercially available, differentially steered EPW, modified for real-time control. The EPW is propelled by two motors and has two front and back casters for balancing. The motors are driven by current controlled motor drivers and they are equipped with encoders that are directly coupled to their shafts. A data acquisition board (i.e. a Sensoray 526) was used to read joystick signals and also processes the encoder signals. The board has several digital to analog channels used to send command signals to the motor drivers. A PIII-computer system controls the experimental setup and runs the QNX operating system such that the sampling rate is 1 kHz.

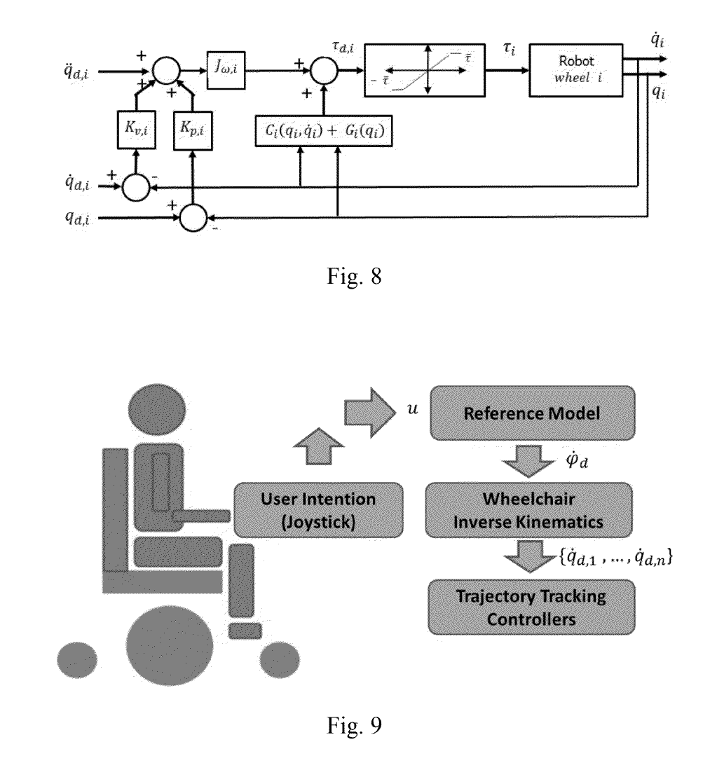

FIG. 8 shows the trajectory tracking controller used to control wheel i of the experimental setup. The inputs were the desired angular acceleration \ddot{q}_{d,i}, angular velocity, q_{d,i} and angular position q_{d,i} of the wheel. The desired wheel torque τ_{d,i} is calculated using

τ_{d,i}=J_{ω,i}(\ddot{q}_{d,i}+K_{v,i}(\dot{q}_{d,i}−\dot{q}ᵢ)+K_{p,i}(q_{d,i}−qᵢ))+Cᵢ(qᵢ,\dot{q}ᵢ)+Gᵢ(qᵢ) (3)

where J_{ω,i} is the wheel inertia, K_{v,i} and K_{p,i} are the feedback gains, Cᵢ(qᵢ, \dot{q}ᵢ) is the friction term seen at wheel i, and Gᵢ(qᵢ) is the gravity term seen at wheel i. In FIG. 8, τ̅ is the maximum torque of the drive motors and defines a saturation function that determines the torque τᵢ actually commanded to the robot wheel.

Electric Powered Wheelchair Control Based on Reference Model

Motivated by results in which a model reference control scheme was used with a walker [8], a motion control algorithm based on a reference model was used to address the interaction between the user and EPW. The resulting control architecture is shown in FIG. 9. User intentions, represented by the joystick displacements, were mapped into virtual force/torque values, which constitute the elements of u∈ [symbol] ², the input to the reference model,

$$\begin{matrix}{M}_{d \ddot{ϕ} d} + {M}_{d \dot{ϕ} d} = u & ( 4 ) \\ where & \\ {M}_{d} = [ \begin{matrix}{m}_{x} & 0 \\ 0 & {m}_{θ}\end{matrix} ] , {D}_{d} = [ \begin{matrix}{d}_{x} & 0 \\ 0 & {d}_{θ}\end{matrix} ] , {\dot{ϕ}}_{d} = [ \begin{matrix}{v}_{R , d} \\ {ω}_{R , d}\end{matrix} ] , u = [ \begin{matrix}{u}_{x} \\ {u}_{θ}\end{matrix} ] & ( 5 )\end{matrix}$$

Referring to FIG. 7, the subscript x denotes relationship to the x_{R}-axis and subscript θ denotes rotation about the z_{R}-axis. The left wheel was denoted as wheel 1 and the right wheel as wheel 2. The output of the reference model is \dot{φ}_{d} and the desired angular velocities {\dot{q}_{d,1}, \dot{q}_{d,2}} for the 2 drive wheels were determined through the inverse kinematics. The desired accelerations {\ddot{q}_{d,1}, \ddot{q}_{d,2}} and desired positions {q_{d,1}, q_{d,2}} were then respectively determined by differentiation and integration of the desired velocities. The controller in FIG. 9 tracks \ddot{q}_{d,i}, \dot{q}_{d,i}, and q_{d,i}.

Slip Control Using Variable Reference Model and Maximum Tractive Force Estimate

Slip control along the longitudinal direction of an EPW can be accomplished through parameter variation in the reference model. The reference model in (4) with u=[uₓ 0]^{T} simplifies to

mₓ\ddot{x}_{R}+dₓ\dot{x}_{R}=uₓ (6)

Assuming that the vehicle was moving under driver control with nominal values of the parameters of the reference model (6) given by mₓ=m_{x,0} and dₓ=d_{x,0}. The proposed slip control concept was based on monitoring the traction force estimate \hat{F}_{d,i} for wheel i as computed in FIG. 7(b) as the vehicle accelerated over a given (small) period to determine an estimate \hat{F}_{d,i}_{ₘₐₓ}, of the maximum tractive force for wheel i. Then \hat{F}_{d}_{ₘₐₓ} was defined as \hat{F}_{d}_{ₘₐₓ}=min_{j∈{1,2}}\hat{F}_{d,j}_{ₘₐₓ} . Assuming that the minimum occurs for wheel J* and \hat{F}_{d}_{ₘₐₓ}=\hat{F}_{d,j}*(t*), the tractive force estimate for wheel J* evaluated at time t*. The idea was to modify (if necessary) mₓ in (6) such that it produced future desired vehicle accelerations that did not require a tractive force from any of the wheels that exceeded \hat{F}_{d}_{ₘₐₓ}. Note that since \hat{F}_{d}_{ₘₐₓ} is the minimum of the estimated maximum tractive force over each wheel, this strategy sought to ensure that no wheel required a tractive force not capable of being achieved by every other wheel. This is important since, for example, a vehicle can move longitudinally in a straight line only if the tractive force applied to each wheel is the same.

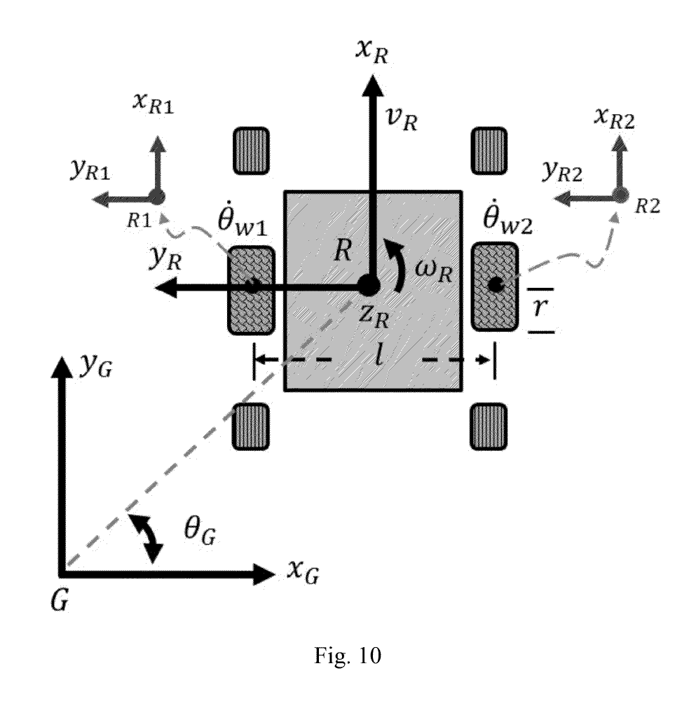

To determine a constraint on mₓ, wheel i was analyzed to determine a constraint on \ddot{x}_{R,1}. The constraints on \ddot{x}_{R,1} and \ddot{x}_{R,2} were then mapped to a constraint on \ddot{x}_{R} using the EPW's kinematics, which were based on FIG. 10. The translational dynamics (2) for wheel i are rewritten here as

Mᵢ\ddot{x}_{R,i}=F_{d,i}−F_{r,i} (7)

It follows from (7) that if it is desired to ensure F_{d,i}<\hat{F}_{d}_{ₘₐₓ}, then if F_{r,i}<<F_{d,i}, it is desired that

\ddot{x}_{R,i}<\hat{F}_{d}_{ₘₐₓ}/Mᵢ (8)

Given that [\ddot{x}_{R} \ddot{θ}_{R}]^{T}= [symbol] [\ddot{x}_{R,1} \ddot{x}_{R,2}]^{T}, where [symbol] is the wheelchair's Jacobian matrix. It is also desired that

$${\ddot{x}}_{R} < {\hat{F}}_{{d}_{max}} {\sum }_{i = 1}^{2} \frac{{𝕁}_{1 , i}}{{M}_{i}} \qquad ( 9 )$$

where [symbol] _{1,i} is the (1, i) element of [symbol] . For the experimental wheelchair, which has the kinematics of FIG. 10, [symbol] _{1,1}= [symbol] _{1,2}=1/2 and M₁=M₂=M/2, where M=90 kg was the total mass of the wheelchair. To ensure (9) is satisfied, (6) was used to choose

mₓ>1/\hat{F}_{d}_{ₘₐₓ}Σᵢ₌₁² [symbol] _{1,i}/Mᵢ(uₓ(t*)−d_{x,0}\dot{x}_{R}(t*)) (10)

The inequality in (10) essentially ensures that if the initial command profile uₓ(t) were repeated, the traction force required by any of the wheels would not exceed \hat{F}_{d}_{ₘₐₓ}. Note that if mₓ=m_{x,0} satisfies (10), then mₓ does not have to be increased. Also, once mₓ is increased, it can later be reduced, for example, when the acceleration of the EPW is smaller than some threshold.

Experiments and Results

Experiments were performed to evaluate the slip mitigation approach for an EPW. These experiments did not involve a human driver. Instead, the wheelchair was commanded remotely as if a user were choosing the joystick setting to command the wheelchair to move straight in the longitudinal direction, i.e., u_{θ}=0. In all the experiments, the input uₓ was given by

$${u}_{x} = \{ \begin{matrix}100 N , t ∈ [ 0 , 3 ] sec \\ 0 , t > 3 sec\end{matrix} \qquad ( 11 )$$

Initially mₓ=m_{x,0}=75 kg and dₓ=d_{x,0}=100 kg/s. These values were chosen so that the reference model (6) yields a maximum commanded acceleration \ddot{x}_{R,d} from rest of 1.33 m/s² and a maximum steady-state velocity \dot{x}_{R,d} of 1 m/s. The actual maximum linear acceleration for the experimental setup was 2 m/s² and the maximum linear velocity was 1.5 m/s, while the actual mass of the wheelchair was 90 kg. Referring to FIG. 7, the gear resistances τ_{r,1} and τ_{r,2} were determined by measuring the torque of each wheel while the EPW was raised so that the wheels were not in contact with the ground.

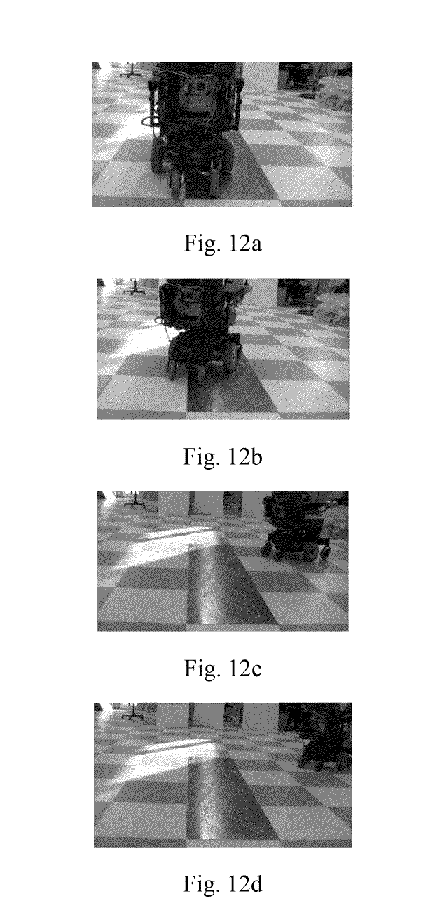

Experiments were conducted to evaluate the EPW movements. The first set of experiments used the reference model (6) for both wheels with mₓ=m_{x,0} and dₓ=d_{x,0}, which was the baseline control. The second set allowed the value of mₓ to change to satisfy (10), such that slip mitigation control was enabled. As shown in FIG. 12, the right wheels of the EPW were initially placed on a slippery surface, which was an aluminum sheet covered with soapy water, and the left wheels were placed on a high traction surface, which was a vinyl floor. Since the vehicle was commanded to move straight in the longitudinal direction, the tractive forces applied to the two wheels should have been approximately equal, so that \hat{F}_{d,1}=\hat{F}_{d,2}.

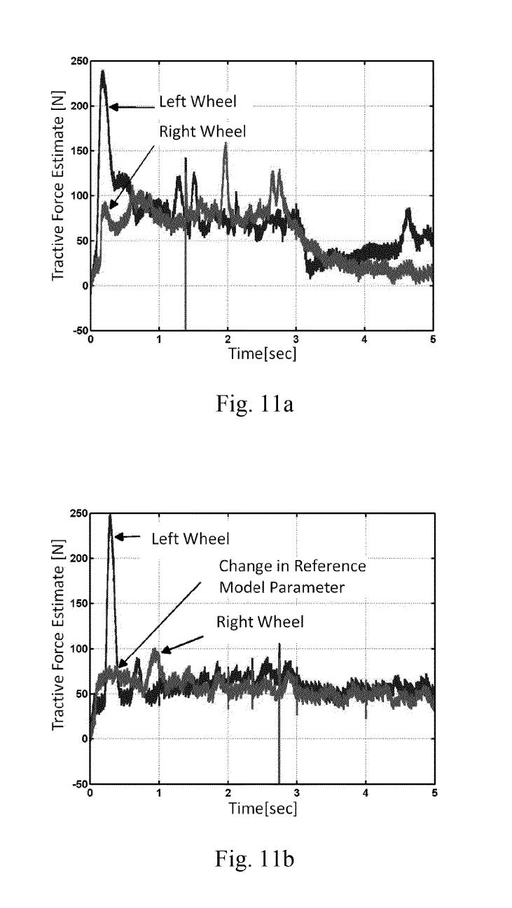

FIGS. 12(a)-(d) show snapshots of the EPW trajectory under baseline control. Notice that the EPW curves to the right due to the loss of traction in the right drive wheel. FIG. 11(a) shows the estimated driving forces \hat{F}_{d,1} and \hat{F}_{d,2}. Note that in general \hat{F}_{d,1}≠\hat{F}_{d,2}, which accounts for the lack of linear motion.

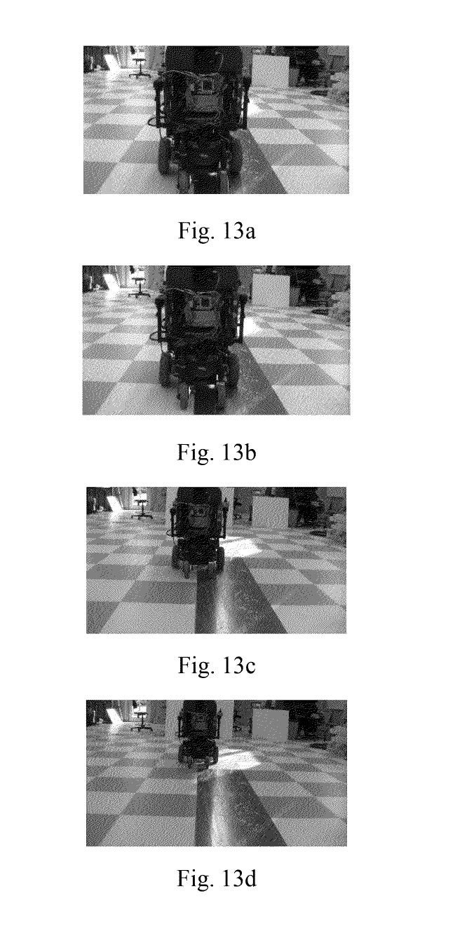

In the implementation of slip control, the value of \hat{F}_{d,i} was continuously updated during acceleration and if \hat{F}_{d,i}>\hat{F}_{d,i}_{ₘₐₓ} then \hat{F}_{d,i}_{ₘₐₓ}←\hat{F}_{d,i}. The detection of \hat{F}_{d,i}_{ₘₐₓ} stopped if (\hat{F}_{d,i}_{ₘₐₓ}−\hat{F}_{d,i}>3σ, where σ=7.5N, was the standard deviation of \hat{F}_{d,i}_{ₘₐₓ} for t∈[t₀, t₀+5 sec], an interval at time in which the vehicle was moving only on the high traction vinyl surface. Using this method \hat{F}_{d}_{ₘₐₓ}=\hat{F}_{d,2}(0.25 sec). Due to the right wheel's movement on the slippery surface, it was found at time t=t*=0.29 sec that (10) was violated. The mass was then updated using

$${m}_{x} = {m}_{x , 0} + β \frac{{M}_{{i}_{*}}}{{\hat{F}}_{{d}_{max}}} ( {u}_{x} ( {t}_{*} ) - {d}_{x , 0} {\dot{x}}_{R} ( {t}_{*} ) ) \qquad ( 12 )$$

where β is a tuning factor that helps to account for the overestimation of \hat{F}_{d}_{ₘₐₓ}. In these experiments β=1 and mₓ was updated to m_{x,new}=225 kg. FIGS. 13(a)-(d) shows that the EPW behavior was able to move straight (with only a small heading error) due to the slip mitigation control, although the right drive wheel of the EPW did experience some initial slip as evidenced by the fact that FIG. 11(b) shows that before mₓ was updated at t=t*=0.29 sec, \hat{F}_{d,2} was substantially less than \hat{F}_{d,1} due to the loss of traction in wheel 2 as it moved on the slippery surface. However, after the update of mₓ, \hat{F}_{d,1}≈\hat{F}_{d,2} as desired, resulting in the desired linear motion. The slip control evaluation was repeated five times and the average heading error was approximately 3.822 degrees.

### CONCLUSION

This study presented an approach to slip mitigation control for an EPW based on variable mass-damper reference model. An estimate of the maximum tractive force for each wheel was determined and the minimum of the maximum tractive forces were used to solve for the feasible linear accelerations of the wheels. The vehicle Jacobian matrix was used to transform the constraints on the wheel accelerations to a constraint on the acceleration of the wheelchair body, which in turn yielded a constraint on the mass of the reference model. When the mass constraint was violated, i.e., slip occurs, the mass was updated to ensure that future trajectories did not require any wheel to have more tractive force than could be provided to each of the wheels. An experiment was performed to show the viability of this approach. Although the developments were only for movements in the longitudinal direction, the analysis was based on the wheels and can be extended to general curvilinear motion.

Glossary of Claim Terms

Mass-Damper Model: is a model of a device that can be attached to a structure to reduce the dynamic response of the structure.

Maximum Tractive Force Estimator: is a control system designed to calculate the maximum tractive force.

Trajectory Tracking Controller: is a control system used to effect desired trajectories of the object, which is subject to the controller.

User Input: is any form of user-initiated feedback that affects the motion of the vehicle.

Wheel: is a structure attached to a vehicle to enable the vehicle to move across a surface.

### REFERENCES

[1] K. Choi, M. Sato, and Y. Koike. A new, human-centered wheelchair system controlled by the EMG signal. In 2006 International Joint Conference on Neural Networks, pages 4664-4671, 2006.

[2] D. Ding and R. Cooper. Electric powered wheelchairs: A review of current technology and insight into future directions. IEEE Control Systems Magazine, pages 22-34, 2005.

[3] K. Fujii and H. Fujimoto. Traction control based on slip ratio estimation without detecting vehicle speed for electric vehicle. In Power Conversion Conference, pages 688-693, 2007.

[4] F. Gustafsson. Slip-based tire-road friction estimation. Automatica, 33(6):1087-1099,1997.

[5] Y. Hori, Y. Toyoda, and Y. Tsuruoka. Traction control of electric vehicle: Basic experimental results using the test ev “UOT Electric March”, IEEE Transactions on Industry Applications, 34(5):1131-1138, 1998.

[6] Y. Holi, Y. Toyoda, and Y. Tsuruoka. Future vehicle driven by electricity and control research on four-wheel-motored “UOT Electric March II”. IEEE Transactions on Industrial Electronics, 51(5):954-962, 2004.

[7] O. Chuy Jr., Y. Hirata, and K. Kosuge. A new control approach for a robotic walking support system in adapting user characteristic. IEEE Trans. Syst., Man, Cybern. C, 36(6):725-733, 2006.

[8] O. Chuy Jr., Y. Hirata, Z. Wang, and K. Kosuge. A control approach based on passive behavior to enhance user interaction. IEEE Transactions on Robotics, 23(5):899-908, October 2007.

[9] H. Kataoka, R Sado, I. Sakai, and Y. Hori. Optimal slip ratio estimator for traction control system of electric vehicle based on fuzzy inference. Elect. Eng. Jpn., 135:5663, 2001.

[10] H. Sado, S. Sakai, and Y. Hori. Road condition estimation for traction control in electric vehicle. In Proceedings of the IEEE International Symposium on Industrial Electronics, pages 973-978, 1999.

[11] B. Subudhi and S. Ge, Sliding-mode-observer-based adaptive slip ratio control for electric and hybrid vehicles. IEEE Transactions on Intelligent Transportation Systems, 13(4):1617-1626, 2012.

[12] G. Vasiljevic, K. Griparic, and S. Bogdan. Slip-based traction control system with an on-line road condition estimation for electric vehicles. In 2012 IEEE International Conference on Control Applications, pages 395-400, 2012.

[13] H. Wang, B. Salatin, G. Grindle, D. Ding, and R. Cooper. Real-time model-based electrical powered wheelchair control. In Medical Engineering Physics, pages 1244-1254, 2009.

[14] D. Yin and Y. Hon. A novel traction control for electric vehicle without chassis velocity. INTECH ISBN 978-953-7619-55-8, pages 121-140, 2010.

[15] D. Yin, S. Oh, and Y. Hori. A novel traction control for ev based on maximum transmissible torque estimation. IEEE Transactions on Industrial Electronics, 56(6):2086-2094, 2009.

[16] H. Yu. M. Spenko, and S. Dubowsky. An adaptive control system for an intelligent mobility aid for the elderly. Auton. Robots, 15:53-66, 2003.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A traction control system for a vehicle having two or more wheels, comprising:
a maximum tractive force estimator adapted to determine a maximum tractive force of a wheel to determine a feasible linear acceleration of the wheel;
a reference model in the form of a variable mass-damper system adapted to determine a mass constraint; and
a trajectory tracking controller communicatively coupled to one or more wheels to monitor if the mass constraint is violated and to update a mass value in the reference model to ensure that future trajectories prevent any wheel from needing a tractive force greater than the maximum tractive force.

2. The traction control system of claim 1, wherein the vehicle is an electric ground vehicle.

3. The traction control system of claim 1, further comprising an inertial measurement module, to improve the accuracy of the estimation of the tractive forces.

4. The traction control system of claim 1, wherein the reference model is adapted to generate a desired acceleration, velocity, and position of the vehicle based on user inputs.

5. The traction control system of claim 1, wherein the reference model is adapted to map force and torque inputs.

6. The traction control system of claim 1, further comprising a trajectory tracking controller and a maximum tractive force estimator for each wheel.

7. A method for controlling a traction control system, comprising:
determining a minimum of a maximum tractive force that can be applied to a wheel by a maximum tractive force estimator;
generating a lower bound mass parameter of a reference model;
determining when the wheel is required to follow a trajectory that requires more than the minimum of the maximum tractive force; and
reducing the mass parameter of the reference model.

8. The method of claim 7, further comprising the step of generating a desired acceleration, a desired velocity, and a desired position of a vehicle based on user inputs, by the reference model.

9. The method of claim 7, wherein the reference model is based on a mass-damper system.

10. The method of claim 7, further comprising the step of mapping the user inputs to the reference model.

11. The method of claim 7, further comprising the step of mapping a commanded trajectory to a trajectory tracking controller to control the trajectory of the wheel.

12. The method of claim 7, wherein the step of generating a lower bound mass parameter of the reference model is accomplished using a Jacobian matrix of a vehicle subjected to the traction control system to transform a constraint on wheel acceleration to a constraint on vehicle acceleration and in turn yield the lower bound mass parameter of the reference model.

13. The method of claim 7, wherein the step of mapping a commanded trajectory is accomplished using an inverse of a Jacobian matrix of a vehicle subjected to the traction control system.

14. The method of claim 7, wherein the step of mapping the user inputs includes force inputs and torque inputs.

15. A method for controlling an electric ground vehicle's traction, comprising:
generating a desired acceleration, a desired velocity, and a desired position of the vehicle based on user inputs by a reference model;
mapping the user inputs to the reference model;
mapping a commanded trajectory to a trajectory tracking controller;
controlling the wheel's trajectory by the trajectory tracking controller;
determining a minimum of a maximum tractive force that can be applied to the wheel, by a maximum tractive force estimator;
generating a lower bound mass parameter of the reference model;
determining when the wheel is required to follow a trajectory that requires more than the minimum of the maximum tractive force; and
reducing the mass parameter of the reference model.

16. The method of claim 15, wherein the step of generating a lower bound mass parameter of the reference model is accomplished using a Jacobian matrix of the electric ground vehicle to transform a constraint on wheel acceleration to a constraint on electric ground vehicle acceleration and in turn yield the lower bound mass parameter of the reference model.

17. The method of claim 15, wherein the step of mapping a commanded trajectory is accomplished using an inverse of a Jacobian matrix of the electric ground vehicle.

18. The method of claim 15, wherein the step of mapping the user inputs includes force inputs and torque inputs.
